(19) United States
(12) Patent Application Publication
(10) Pub. No.: US 2026/0186337 A1
(43) Pub. Date: Jul. 2, 2026

(54) SWITCHABLE OPTICAL ELEMENT AND SWITCHABLE DISPLAY DEVICE

(71) Applicant: Innolux Corporation, Miaoli County (TW)

(72) Inventors: Chih-Chin Kuo, Miaoli County (TW); Jin Yi Tan, Miaoli County (TW); Ying-Jen Chen, Miaoli County (TW)

(73) Assignee: Innolux Corporation, Miaoli County (TW)

(21) Appl. No.: 19/406,940

(22) Filed: Dec. 3, 2025

Related U.S. Application Data
(60) Provisional application No. 63/741,145, filed on Jan. 2, 2025.

(30) Foreign Application Priority Data
Aug. 26, 2025 (CN) 202511201985.9

(51) Int. Cl. G02F 1/1335; G02F 1/13; G02F 1/1337; G02F 1/1339

(52) U.S. Cl. CPC G02F 1/133526; G02F 1/1323; G02F 1/133565; G02F 1/1337; G02F 1/13394

(57) ABSTRACT

A switchable optical element including a first substrate, a second substrate, a switching medium, multiple lenses, and multiple spacers is provided. The second substrate is opposite to the first substrate. The switching medium is disposed between the first substrate and the second substrate. The lenses are disposed on the second substrate. The spacers are disposed between the lenses and the first substrate. In a cross-sectional direction of the switchable optical element, at least one of the spacers is disposed corresponding to at least one of the lenses. A switchable display device is also provided.

### CROSS-REFERENCE TO RELATED APPLICATION

This application claims the priority benefit of U.S. provisional application serial no. 63/741,145, filed on January 2, 2025, and China application serial no. 202511201985.9, filed on August 26, 2025. The entirety of each of the above-mentioned patent applications is hereby incorporated by reference herein and made a part of this specification.

### BACKGROUND

### Technical Field

The disclosure relates to an optical element and an electronic device, and in particular to a switchable optical element and a switchable display device.

### Description of Related Art

When assembling a lens substrate with another substrate, a uniform gap between the two substrates needs to be maintained to reduce the negative impact on optical quality caused by a non-uniform gap.

### SUMMARY

The disclosure provides a switchable optical element and a switchable display device, which help to improve gap uniformity.

In an embodiment of the disclosure, a switchable optical element includes a first substrate, a second substrate, a switching medium, multiple lenses, and multiple spacers. The second substrate is opposite to the first substrate. The switching medium is disposed between the first substrate and the second substrate. The lenses are disposed on the second substrate. The spacers are disposed between the lenses and the first substrate. In a cross-sectional direction of the switchable optical element, at least one of the spacers is disposed corresponding to at least one of the lenses.

In another embodiment of the disclosure, a switchable display device includes a display and a switchable optical element disposed on the display. The switchable optical element includes a first substrate, a second substrate, a switching medium, multiple lenses, and multiple spacers. The second substrate is opposite to the first substrate. The switching medium is disposed between the first substrate and the second substrate. The lenses are disposed on the second substrate. The spacers are disposed between the lenses and the first substrate. In a cross-sectional direction of the switchable optical element, at least one of the spacers is disposed corresponding to at least one of the lenses.

In order for the features and advantages of the disclosure to be more comprehensible, the following specific embodiments are described in detail in conjunction with the drawings.

### BRIEF DESCRIPTION OF THE DRAWINGS

FIG. 1 is a partial cross-sectional schematic diagram of a switchable display device according to some embodiments of the disclosure.

FIG. 2 and FIG. 3 are respectively a partial cross-sectional schematic diagram and a partial three-dimensional schematic diagram of a switchable optical element according to some embodiments of the disclosure.

FIG. 4 and FIG. 5 are respectively a partial cross-sectional schematic diagram and a partial three-dimensional schematic diagram of a switchable optical element according to other embodiments of the disclosure.

FIG. 6 is a partial three-dimensional schematic diagram of a switchable optical element according to some other embodiments of the disclosure.

FIG. 7 is a partial cross-sectional diagram of a lens according to some embodiments of the disclosure.

FIG. 8 is a partial three-dimensional schematic diagram of a switchable optical element according to still other embodiments of the disclosure.

FIG. 9 is a partial three-dimensional schematic diagram of a switchable optical element according to other embodiments of the disclosure.

FIG. 10 is a partial cross-sectional schematic diagram of a switchable optical element according to other embodiments of the disclosure.

### DESCRIPTION OF THE EMBODIMENTS

Reference will now be made in detail to the exemplary embodiments of the disclosure, and examples of the exemplary embodiments are illustrated in the drawings. Wherever possible, the same reference numerals are used in the drawings and the description to refer to the same or similar parts.

In the disclosure, the electronic device may include a light emitting device, a display device, a backlight device, or a splicing device, but not limited thereto. The electronic device may be a bendable or flexible electronic device. The display device may be a non-self-luminous display device or a self-luminous display device. The display device may, for example, include liquid crystal, a light emitting diode, fluorescence, phosphor, quantum dot (QD), other suitable display media, or a combination of the above.

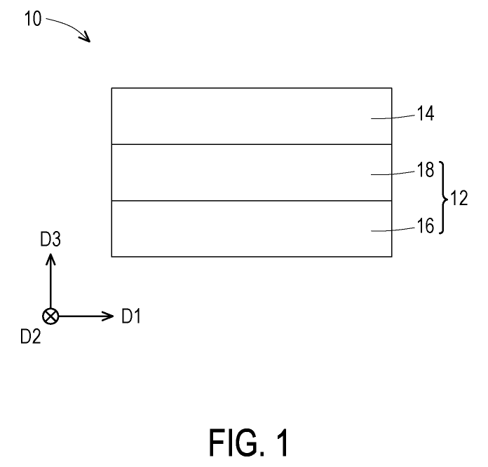

Please first refer to FIG. 1 to FIG. 3. A switchable display device 10 may include a display 12 and a switchable optical element 14 disposed on the display 12. The switchable optical element 14 may include a first substrate 20, a second substrate 22, a switching medium 24, multiple lenses 26, and multiple spacers 28. The second substrate 22 is opposite to the first substrate 20. The switching medium 24 is disposed between the first substrate 20 and the second substrate 22. The lenses 26 are disposed on the second substrate 22. The spacers 28 are disposed between the lenses 26 and the first substrate 20. In a cross-sectional direction (for example, a direction D3) of the switchable optical element 14, at least one of the spacers 28 is disposed corresponding to at least one of the lenses 26.

In detail, please refer to FIG. 1. The display 12 may be used to provide a display image. In some embodiments, as shown in FIG. 1, the display 12 may be a non-self-luminous display and include a light source module 16 and a display panel 18.

The light source module 16 may be used to provide light. For example, the light source module 16 may be an edge-lit light source module or a direct-lit light source module, and the detailed structure of the light source module 16 is not limited here.

The display panel 18 is disposed on a transmission path of the light emitted by the light source module 16 to convert the light into display light carrying display information (for example, color, grayscale, or a combination thereof). Taking FIG. 1 as an example, a top surface of the light source module 16 (the surface of the light source module 16 adjacent to the display panel 18) may be a light emitting surface, that is, the light from the light source module 16 is emitted from the top surface of the light source module 16. The display panel 18 may be disposed above the top surface of the light source module 16 to receive the light emitted from the light source module 16 and convert the light into the display light. For example, the display panel 18 may be a liquid crystal display panel or other types of non-self-luminous display panels, and the detailed structure of the display panel 18 is not limited here.

In other embodiments, although not shown, the display 12 may be a self-luminous display and include multiple light emitting diodes. The light emitting diodes may include multiple organic light emitting diodes, multiple mini light emitting diodes, multiple micro light emitting diodes, or multiple quantum dot light emitting diodes, but not limited thereto.

The switchable optical element 14 is disposed on a transmission path of display light emitted by the display 12 to change the light emission angle, the range, etc. of the switchable display device 10. Taking FIG. 1 as an example, a top surface of the display panel 18 (the surface of the display panel 18 adjacent to the switchable optical element 14) may be a light emitting surface, that is, the display light from the display panel 18 is emitted from the top surface of the display panel 18. The switchable optical element 14 may be disposed above the top surface of the display panel 18 to receive the display light emitted from the display panel 18 and change the emission angle, the range, etc. of the display light.

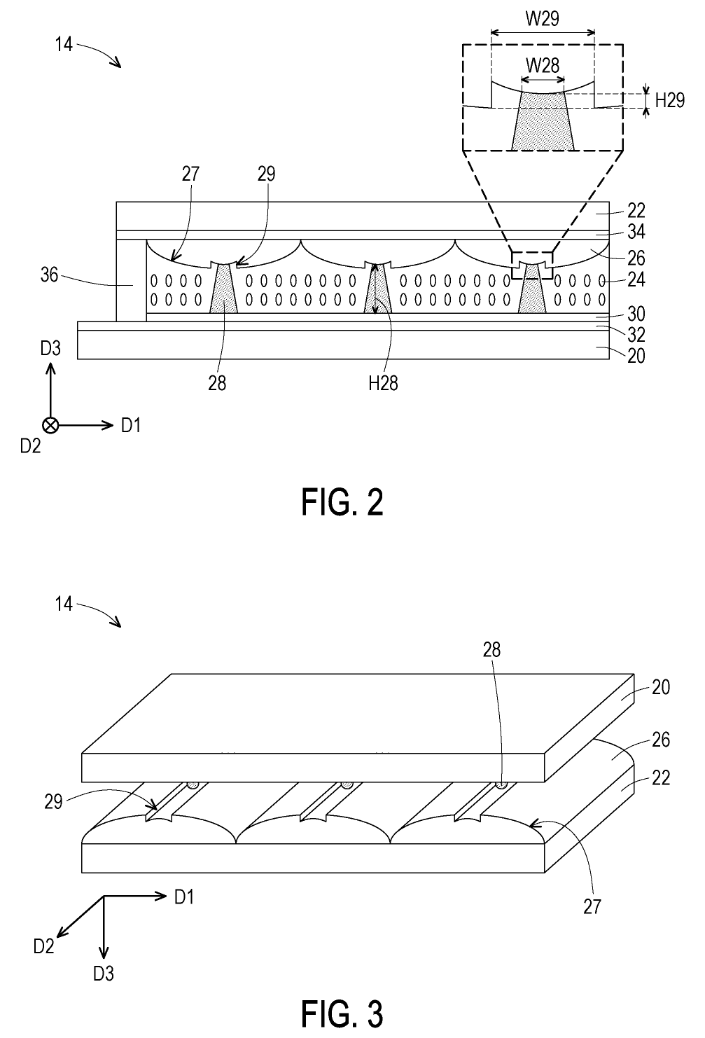

Please refer to FIG. 2 and FIG. 3. In the switchable optical element 14, the first substrate 20 is disposed above the display 12. In some embodiments, although not shown, the first substrate 20 may be fixed onto the display 12 through an adhesive layer, a mechanical member, etc. The adhesive layer may include an optical clear adhesive (OCA) or an optical clear resin (OCR), but not limited thereto. The adhesive layer may be entirely or partially coated on a overlapping region between the first substrate 20 and the display 12. For example, the adhesive layer may be coated only on a peripheral region between the first substrate 20 and the display 12, so that the adhesive layer forms a hollow rectangular shape in the top view, and an air gap may be included between the first substrate 20 and the display 12. Alternatively, the adhesive layer may cover the entire region between the first substrate 20 and the display 12, and there may be no air gap between the first substrate 20 and the display 12.

The first substrate 20 may be an element array substrate. Although not shown, the first substrate 20 may include a substrate and an element array disposed on the substrate. The substrate may be a light transmitting substrate, and the substrate may be a hard substrate or a flexible substrate. The material of the substrate, for example, includes glass, quartz, ceramic, sapphire, plastic, etc., but not limited thereto. The plastic may include polycarbonate (PC), polyimide (PI), polypropylene (PP), polyethylene terephthalate (PET), polyacrylic acid (PAA), other suitable flexible materials, or a combination of the above materials, but not limited thereto. The element array may include multiple active elements, multiple passive elements, or a combination thereof, but not limited thereto.

The second substrate 22 is disposed opposite to the first substrate 20 in the direction D3, and the second substrate 22 is disposed on a side of the first substrate 20 away from the display 12, that is, the first substrate 20 is disposed between the second substrate 22 and the display 12. The second substrate 22 may be a light transmitting hard substrate or a light transmitting flexible substrate. The material of the second substrate 22, for example, includes glass, quartz, ceramic, sapphire, plastic, etc., but not limited thereto.

The switching medium 24 may be disposed between the first substrate 20 and the lenses 26. The switching medium 24 may include liquid crystal or other media with adjustable refractive indexes.

The lenses 26 may be disposed on a surface of the second substrate 22 facing the first substrate 20, and the spacers 28 may be disposed on a surface of the first substrate 20 facing the second substrate 22, and in the cross-sectional direction (for example, the direction D3) of the switchable optical element 14, at least one spacer 28 may abut against at least one lens 26. For example, each spacer 28 may abut against one corresponding lens 26. In addition, each lens 26 may abut against one or more spacers 28. Alternatively, at least one of the lenses 26 may abut against one or more spacers 28, and at least another one of the lenses 26 may not abut against any spacer 28. For example, the odd-numbered (or the even-numbered) lenses 26 among the lenses 26 arranged along a direction D1 may abut against one or more spacers 28, and the even-numbered (or the odd-numbered) lenses 26 among the lenses 26 arranged along the direction D1 may not abut against any spacer 28.

Through the design of the lenses 26 and the spacers 28 abutting against each other in the cross-sectional direction (for example, the direction D3) of the switchable optical element 14, the uniformity of the gap between the first substrate 20 and the second substrate 22 may be maintained, so as to reduce the negative impact on optical quality caused by a non-uniform gap.

In some embodiments, as shown in FIG. 2 and FIG. 3, one of the lenses 26 may have a curved surface 27, and the curved surface 27 may have at least one notch 29. In the cross-sectional direction (for example, the direction D3) of the switchable optical element 14, at least one of the spacers 28 may be disposed corresponding to the at least one notch 29. For example, at least one or each of the lenses 26 may have the curved surface 27 protruding toward the first substrate 20, and the notch 29 may be located in a central region of the curved surface 27. Each spacer 28 may abut against one corresponding notch 29.

In some embodiments, as shown in FIG. 3, the lenses 26 may include multiple cylindrical lenses. The cylindrical lenses, for example, are arranged along the direction D1 and extend along a direction D2. The direction D1 and the direction D2 intersect each other and are both perpendicular to the direction D3. In some embodiments, the direction D1 and the direction D2 are perpendicular to each other, but not limited thereto. In some embodiments, although not shown, the lenses 26 may be disposed on a lens substrate, wherein the lens substrate may be disposed between the lenses 26 and the second substrate 22. The material of the lens substrate may include glass, polyimide, or polyacrylic acid, but not limited thereto.

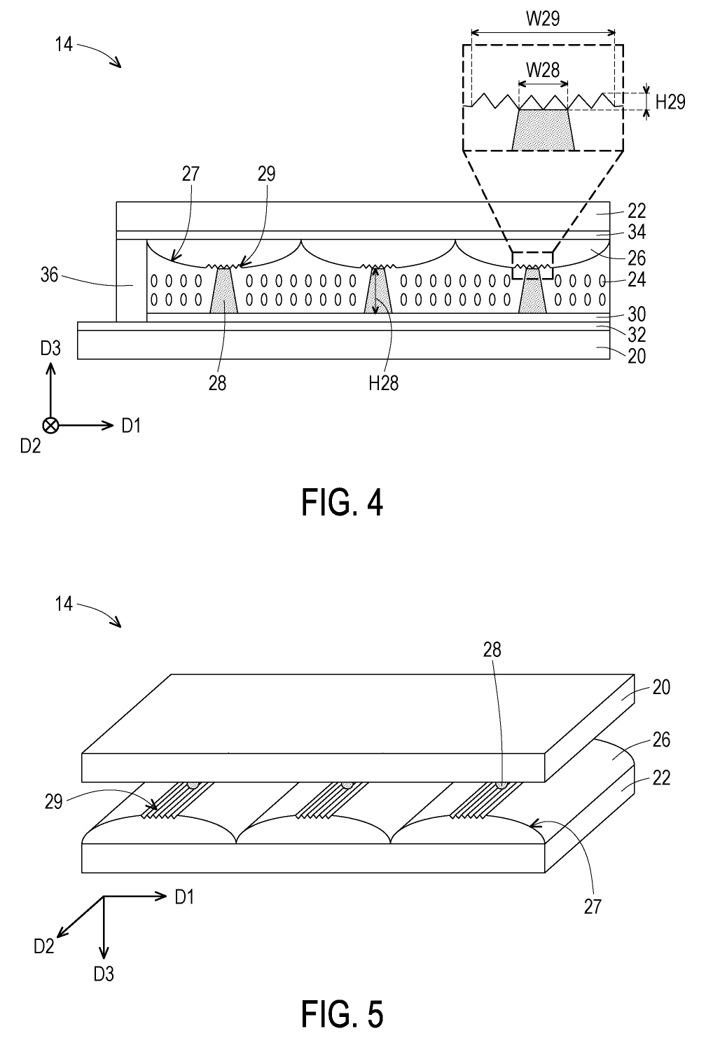

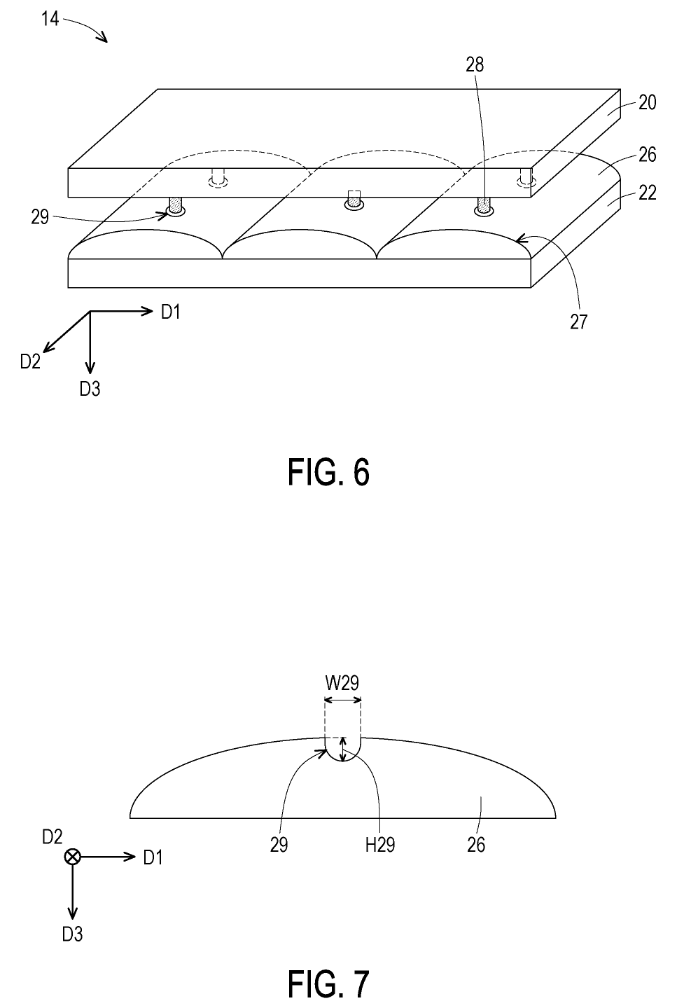

In some embodiments, at least one notch 29 may include at least one groove (refer to FIG. 2 and FIG. 3), at least one slit (refer to FIG. 4 and FIG. 5), or at least one hole (refer to FIG. 6 and FIG. 7).

Through the design of the notch 29, the convenience of assembling the lens 26 and the spacer 28 may be improved and/or the horizontal displacement of the spacer 28 and the lens 26 in the direction D1 may be reduced. In some embodiments, a width difference between at least one of the spacers 28 and at least one notch 29 is within a range of 2 μm to 20 μm. As shown in FIG. 2, a width W28 of the spacer 28 (the width of the spacer 28 at the end close to the notch 29) is, for example, less than a width W29 of the notch 29, so that the spacer 28 can extend into the notch 29. In addition, the width difference (W29-W28) between the spacer 28 and the notch 29 may be within a range of 2 μm to 20 μm to reduce the alignment difficulty and reduce the horizontal displacement of the spacer 28 and the lens 26 in the direction D1. In some embodiments, based on process and optical considerations, a ratio (W26/W29) of the width W26 of the lens 26 (or the pitch of the lenses 26) to the width W29 of the notch 29 is, for example, greater than 10 and less than 100. In some embodiments, based on process and optical considerations, a depth H29 of at least one notch 29 may be designed to be less than one tenth of a height H28 of at least one of the spacers 28, but not limited thereto.

Although FIG. 2 schematically illustrates that the cross-sectional shape of the spacer 28 is a trapezoid, the cross-sectional shape of the spacer 28 may be changed according to requirements and is not limited to that shown in FIG. 2. For example, the cross-sectional shape of the spacer 28 may be a rectangle or other polygons.

In some embodiments, based on considerations such as maintaining the gap and vacuum assembly, the density range of the spacers 28 may be from 5 to 200 per mm².

In some embodiments, as shown in FIG. 2, the switchable optical element 14 may further include an alignment layer 30 and a first electrode 32, wherein the alignment layer 30 is disposed between the spacers 28 and the first substrate 20, and the first electrode 32 is disposed between the alignment layer 30 and the first substrate 20. Through the design of the notch 29, the horizontal displacement of the spacer 28 and the lens 26 in the direction D1 may be reduced, thereby lowering the probability of scratching the alignment layer 30 to maintain the integrity of the alignment layer 30, and reduce display defects such as mura or sparkling caused by scratches on the alignment layer 30. The material of the first electrode 32 may include a transparent conductive material, such as indium tin oxide (ITO), indium zinc oxide (IZO), or indium gallium zinc oxide (IGZO), but not limited thereto.

In some embodiments, as shown in FIG. 2, the switchable optical element 14 may further include a second electrode 34 disposed between the lenses 26 and the second substrate 22. The material of the second electrode 34 may include a transparent conductive material, but not limited thereto.

In embodiment where the switching medium 24 includes liquid crystal, the tilting direction of liquid crystal molecules in the switching medium 24 is changed through changing a voltage difference between the first electrode 32 and the second electrode 34, which may change the effective refractive index of the switching medium 24, so as to implement two-dimensional (2D)/three-dimensional (3D) conversion, thereby generating a stereoscopic image or a planar image.

In some embodiments, the switchable optical element 14 may further include a seal 36 disposed between the first electrode 32 and the second electrode 34. The seal 36, the first substrate 20, and the second substrate 22 jointly enclose to form a space for accommodating the switching medium 24.

In some embodiments, as shown in FIG. 4 and FIG. 5, at least one notch 29 may include at least one slit. The depth and the width of the slit may be less than the depth and the width of the groove. The slit may be used to increase friction with the spacer 28, so as to fix the first substrate 20 and the second substrate 22. In some embodiments, the surface roughness of a region where the at least one slit is at may be within a range of 0.025 Ra to 16 Ra. In some embodiments, as shown in FIG. 5, the top view shape of the region where the slit is at may be a strip shape, but not limited thereto. In other embodiments, although not shown, the top view shape of the region where the slit is at may be a dot or other polygons.

In some embodiments, as shown in FIG. 6 and FIG. 7, at least one notch 29 may include at least one hole, and each spacer 28 may extend into one corresponding hole. In some embodiments, as shown in FIG. 6, different lenses 26 may have the same number or different numbers of the notches 29, and the notches 29 may be arranged in an array or arbitrarily arranged.

In some embodiments, as shown in FIG. 7, the cross-sectional shape of the hole may be a semicircle (generally referring to a non-complete circle, and not limited to half of a circle), but not limited thereto. In other embodiments, although not shown, the cross-sectional shape of the hole may be an ellipse or other polygons, such as a triangle, a quadrilateral, or other irregular shapes.

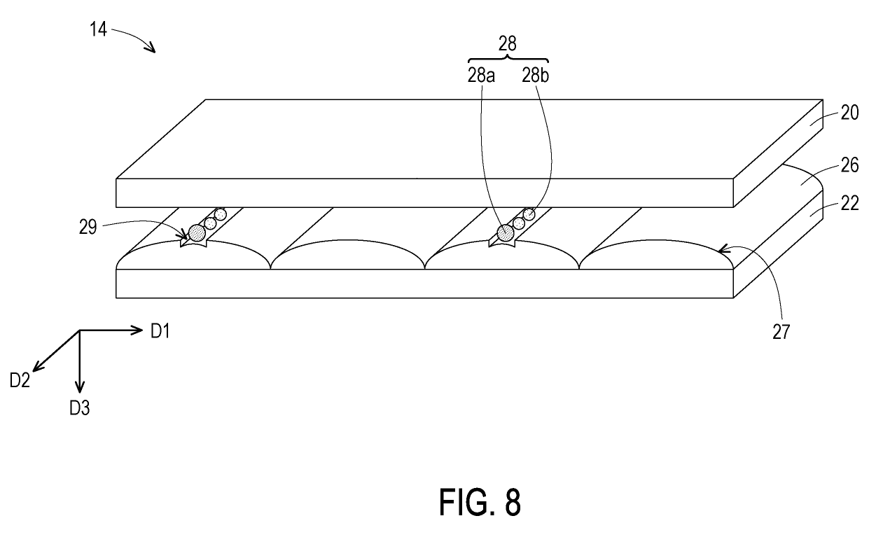

In some embodiments, as shown in FIG. 8, the spacers 28 may include one or more main spacers 28a and one or more secondary spacers 28b, wherein the thickness of the main spacer 28a is greater than the thickness of the secondary spacer 28b. In some embodiments, as shown in FIG. 8, one lens 26 may correspond to one or more main spacers 28a and/or one or more secondary spacers 28b. In some embodiments, a ratio of the sum of bottom areas of the main spacers 28a (the areas of the surfaces of the main spacers 28a facing the first substrate 20) to the surface of the first substrate 20 is, for example, greater than 0.005% and less than 0.1%. In some embodiments, a ratio of the sum of bottom areas of the secondary spacers 28b (the areas of the surfaces of the secondary spacers 28b facing the first substrate 20) to the surface of the first substrate 20 is, for example, greater than 1% and less than 3%.

In some embodiments, as shown in FIG. 8, the odd-numbered (or the even-numbered) lenses 26 among the lenses 26 arranged along the direction D1 may correspond to one or more spacers 28, and the even-numbered (or the odd-numbered) lenses 26 among the lenses 26 arranged along the direction D1 may not correspond to any spacer 28. Furthermore, the even-numbered (or the odd-numbered) lenses 26 among the lenses 26 arranged along the direction D1 may not include the notch 29. Through disposing the notches 29 at intervals, the process window of a filling process (for example, a one drop filling (ODF) process) of the switching medium may be improved and/or the generation of large-area defects may be reduced, which helps to reduce the visibility of display defects.

Although the notch 29 in FIG. 8 is exemplified as a groove, it should be understood that the groove in FIG. 8 may be replaced by the slit or the hole.

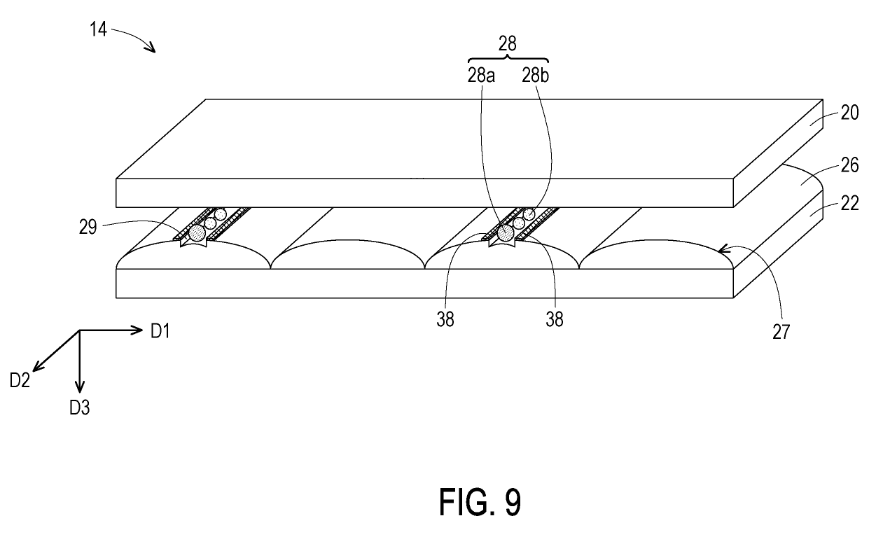

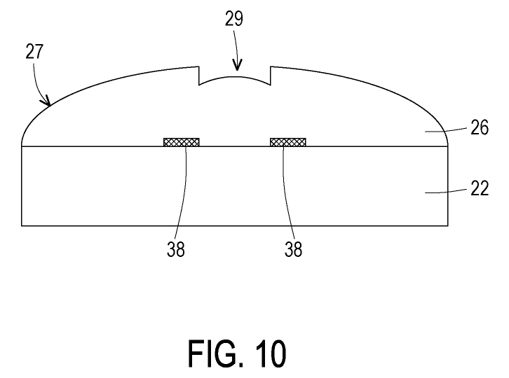

In some embodiments, as shown in FIG. 9, the switchable optical element 14 may further include a light shielding pattern 38 to reduce crosstalk when generating a stereoscopic image. The light shielding pattern 38 may be disposed adjacent to an edge of the notch 29. As shown in FIG. 9, an extending direction of the light shielding pattern 38 may be parallel to an extending direction (for example, the direction D2) of the notch 29. In some embodiments, as shown in FIG. 9, the light shielding pattern 38 may be disposed on the curved surface 27 of the lens 26 and located on two sides of the notch 29. Alternatively, as shown in FIG. 10, the light shielding pattern 38 may be disposed between the second substrate 22 and the lens 26 and disposed corresponding to two sides of the notch 29. The material of the light shielding pattern 38 may include a black matrix or other light absorbing or light reflecting materials.

In summary, in the embodiments of the disclosure, through the design of the lenses and the spacers abutting against each other in the cross-sectional direction of the switchable optical element, the uniformity of the gap between the first substrate and the second substrate may be maintained, so as to reduce the negative impact on optical quality caused by a non-uniform gap.

What is claimed is:

1. A switchable optical element, comprising:
a first substrate;
a second substrate, opposite to the first substrate;
a switching medium, disposed between the first substrate and the second substrate;
a plurality of lenses, disposed on the second substrate; and
a plurality of spacers, disposed between the lenses and the first substrate,
wherein in a cross-sectional direction of the switchable optical element, at least one of the spacers is disposed corresponding to at least one of the lenses.

2. The switchable optical element according to claim 1, further comprising:
an alignment layer, disposed between the spacers and the first substrate; and
a first electrode, disposed between the alignment layer and the first substrate.

3. The switchable optical element according to claim 2, further comprising:
a second electrode, disposed between the lenses and the second substrate.

4. The switchable optical element according to claim 3, further comprising:
a seal, disposed between the first electrode and the second electrode.

5. The switchable optical element according to claim 1, wherein one of the lenses has a curved surface, the curved surface has at least one notch, and in the cross-sectional direction of the switchable optical element, the at least one of the spacers is disposed corresponding to the at least one notch.

6. The switchable optical element according to claim 5, wherein the lenses comprise a plurality of cylindrical lenses.

7. The switchable optical element according to claim 5, wherein the at least one notch comprises at least one groove, at least one slit, or at least one hole.

8. The switchable optical element according to claim 7, wherein a surface roughness of a region where the at least one slit is at is within a range of 0.025 Ra to 16 Ra.

9. The switchable optical element according to claim 5, wherein a width difference between the at least one of the spacers and the at least one notch is within a range of 2 μm to 20 μm.

10. The switchable optical element according to claim 5, wherein a depth of the at least one notch is less than one tenth of a height of the at least one of the spacers.

11. A switchable display device, comprising:
a display; and
a switchable optical element, disposed on the display and comprising:
a first substrate;
a second substrate, opposite to the first substrate;
a switching medium, disposed between the first substrate and the second substrate;
a plurality of lenses, disposed on the second substrate; and
a plurality of spacers, disposed between the lenses and the first substrate,
wherein in a cross-sectional direction of the switchable optical element, at least one of the spacers is disposed corresponding to at least one of the lenses.

12. The switchable display device according to claim 11, wherein the switchable optical element further comprises:
an alignment layer, disposed between the spacers and the first substrate; and
a first electrode, disposed between the alignment layer and the first substrate.

13. The switchable display device according to claim 12, wherein the switchable optical element further comprises:
a second electrode, disposed between the lenses and the second substrate.

14. The switchable display device according to claim 13, wherein the switchable optical element further comprises:
a seal, disposed between the first electrode and the second electrode.

15. The switchable display device according to claim 11, wherein one of the lenses has a curved surface, the curved surface has at least one notch, and in the cross-sectional direction of the switchable optical element, the at least one of the spacers is disposed corresponding to the at least one notch.

16. The switchable display device according to claim 15, wherein the lenses comprise a plurality of cylindrical lenses.

17. The switchable display device according to claim 15, wherein the at least one notch comprises at least one groove, at least one slit, or at least one hole.

18. The switchable display device according to claim 17, wherein a surface roughness of a region where the at least one slit is at is within a range of 0.025 Ra to 16 Ra.

19. The switchable display device according to claim 15, wherein a width difference between the at least one of the spacers and the at least one notch is within a range of 2 μm to 20 μm.

20. The switchable display device according to claim 15, wherein a depth of the at least one notch is less than one tenth of a height of the at least one of the spacers.
